(19) United States
(12) Patent Application Publication
(10) Pub. No.: US 2025/0076556 A1
(43) Pub. Date: Mar. 6, 2025

(54) POLARIZING PLATE AND OPTICAL DISPLAY APPARATUS

(71) Applicant: SAMSUNG SDI CO., LTD., Yongin-si (KR)

(72) Inventors: Yoon Jung KIM, Suwon-si (KR); Min Jung KIM, Suwon-si (KR); Seon Oh HWANG, Suwon-si (KR); Eun Su PARK, Suwon-si (KR); Yeo Il YUN, Suwon-si (KR); Na Young KIM, Suwon-si (KR); Kwang Ho SHIN, Suwon-si (KR)

(21) Appl. No.: 18/821,874

(22) Filed: Aug. 30, 2024

(30) Foreign Application Priority Data
Sep. 1, 2023 (KR) 10-2023-0116227

(51) Int. Cl. G02B 5/30

(52) U.S. Cl. CPC G02B 5/3058; G02B 5/305; G02B 5/3083

(57) ABSTRACT

A polarizing plate and an optical display apparatus are disclosed. A polarizing plate includes a polarizer and a protective layer on at least one surface of the polarizer, and the polarizer includes a polyvinyl alcohol film containing a dichroic substance and contains zinc cations and potassium cations, and the polarizing plate has a value of 0.1 or less, as calculated according to Equation 1.

### CROSS-REFERENCE TO RELATED APPLICATION

The present application claims priority to and the benefit of Korean Patent Application No. 10-2023-0116227, filed on Sep. 1, 2023 in the Korean Intellectual Property Office, the entire disclosure of which is incorporated herein by reference.

### BACKGROUND

### 1. Field

Aspects of embodiments of the present invention relate to a polarizing plate and an optical display apparatus including the same.

### 2. Description of the Related Art

Polarizing plates are commonly used in light emitting displays or liquid crystal displays. The polarizing plate includes a polarizer that provides a polarization function. The polarization function can be realized by a dichroic material including iodine based dyes or dichroic based dyes.

Polarizing plates require high reliability after being left at high temperature for a long period of time. In recent years, the market for automotive displays, where screens are driven inside vehicles, such as navigation, black boxes, and dashboards, has also been growing. In addition, vehicles may have an interior temperature from −40° C. to 200° C., depending on an external environment, for example, and thus are required to have durability under more harsh conditions than ever before and various temperature conditions. In this regard, polarizing plates require high durability after being left at 95° C. for 1,000 hours. However, it may be desirable that the polarizing plates have high durability to meet these conditions even after being left at 105° C. for 1,000 hours or more.

The background technique of the present invention is disclosed in Korean Patent Laid-open Publication No. 2020-0115071 and the like.

### SUMMARY

According to an aspect of one or more embodiments of the present invention, a polarizing plate that has a significantly low change rate of light transmittance even after being left at 105° C. for 1,500 hours or more is provided.

According to another aspect of one or more embodiments of the present invention, a polarizing plate that is free from reddening and yellowing even after being left at 105° C. for 1,500 hours or more is provided.

In accordance with one or more embodiments of the present invention, a polarizing plate includes: a polarizer and a protective layer on at least one surface of the polarizer, wherein the polarizer includes a polyvinyl alcohol based film containing a dichroic material and contains zinc cations and potassium cations, and wherein the polarizing plate has a value of 0.1 or less, as calculated by Equation 1:

$$Tc ( 400 nm ) / Tc ( 730 nm ) , \qquad Equation 1$$

where Tc (400 nm) is a cross transmittance of the polarizing plate at a wavelength of 400 nm (unit: %), and Tc (730 nm) is a cross transmittance of the polarizing plate at a wavelength of 730 nm (unit: %).

In accordance with another aspect of the present invention, there is provided an optical display apparatus including the polarizing plate.

Embodiments of the present invention provide a polarizing plate that has a significantly low change rate of light transmittance even after being left at 105° C. for 1,500 hours or more.

Further, embodiments of the present invention provide a polarizing plate that is free from reddening and yellowing even after being left at 105° C. for 1,500 hours or more.

### BRIEF DESCRIPTION OF THE DRAWINGS

FIG. 1 is a cross-sectional view of a polarizing plate according to an embodiment of the present invention.

FIG. 2 is a cross-sectional view of a polarizing plate according to another embodiment of the present invention.

FIG. 3 is a graph depicting a relationship between cross transmittance (Y-axis, unit: %) and wavelength (X-axis, unit: nm) for polarizers prepared by varying only the concentration of potassium iodide in a color correction solution.

### DETAILED DESCRIPTION

Herein, some example embodiments of the present invention will be described in further detail with reference to the accompanying drawings such that the present invention can be easily implemented by a person having ordinary knowledge in the art. However, it is to be understood that the present invention may be embodied in different ways and is not limited to the following embodiments.

The terminology used herein is for the purpose of describing example embodiments and is not intended to limit the present invention. Herein, the singular forms “a,” “an,” and “the” are intended to include the plural forms as well, unless the context specifically indicates otherwise.

As used herein to represent a specific numerical range, “X to Y” means “greater than or equal to X and less than or equal to Y (Xs and sY)”.

Herein, “(meth)acryl” refers to acryl and/or methacryl.

Herein, “cations in a polarizer” refers to monovalent or polyvalent cations that can be present in the polarizer, such as zinc cations (e.g., Zn²⁺), potassium cations (e.g., K⁺), sodium cations (e.g., Na⁺), boron cations (e.g., B³⁺), and the like, which may be measured by the following method.

### Method of Measuring Cations in Polarizer

The content of cations in a polarizer may be measured by inductively coupled plasma-optical emission spectrometry (ICP-OES).

Herein, the content of cations in the polarizer is expressed in “wt %”, which is a conversion value of the content of cations in the polarizer measured in ppm by ICP-OES. The content of cations in the polarizer may be determined by ICP-OES by (1) weighing 0.3 g of the polarizer as a sample into a microwave vessel, (2) adding 5 g of nitric acid to the microwave vessel and closing the microwave vessel, (3) performing microwave digestion at 200° C. for 1 hour, (4) transferring and diluting the sample in a diluent solvent (distilled water) to obtain 75 g of the sample after cooling the sample, and (5) measuring the content of cations by ICP-OES, without being limited thereto.

Here, “luminance L,” “color value as,” and “color value bs” of a polarizing plate refer to converted L*a*b values measured at a wavelength of 380 nm to 780 nm, in which “L”, “a*”, and “b*” refer to color values in accordance with CIE 1976 standards. “Luminance L,” “color value as,” and “color value bs” may be measured using a spectrophotometer (V-7100, Jasco Corp.), without being limited thereto.

Herein, “cross transmittance (Tc)” of a polarizing plate may refer to a value measured at a certain wavelength between 380 nm and 780 nm.

Herein, “single transmittance (Ts)” of a polarizing plate refers to an average of single transmittance values measured at a wavelength of 380 nm to 780 nm, which may mean total light transmittance.

Herein, “zinc cation” refers to a cation derived from zinc and may be, for example, Zn²⁺.

Herein, “potassium cation” refers to a cation derived from potassium and may be, for example, K⁺.

Herein, “sodium cation” refers to a cation derived from sodium and may be, for example, Na⁺.

Herein, “boron cation” refers to a cation derived from boron and may be, for example, B³⁺.

Herein, “degree of polarization (PE)” of a polarizing plate may be a value measured at a wavelength of 380 nm to 780 nm.

According to one or more embodiments, a polarizing plate has a significantly low change rate of light transmittance even after being left at 105° C. for 1,500 hours or more and which is free from reddening and yellowing even after being left at 105° C. for 1,500 hours or more. The present invention provides a polarizing plate that has a much lower change rate of light transmittance and is free from reddening or yellowing even after being left at a relatively high temperature and for a relatively long time than existing polarizing plates with improved durability at high temperature.

According to one or more embodiments, the polarizing plate may have a single transmittance change rate of 3% or less, for example, 0% to 3%, as calculated according to Equation 2:

$$Single transmittance change rate = [ \vert Ts 2 - Ts 1 \vert / Ts 1 ] \times 100 , \qquad Equation 2$$

where Ts1 is an initial single transmittance of the polarizing plate (unit: %), and Ts2 is a single transmittance of the polarizing plate after the polarizing plate is left at 105° C. for 1,500 hours (unit: %).

In Equation 2, “initial single transmittance” is a value before the polarizing plate is left at 105° C. for 1,500 hours.

According to one or more embodiments, in Equation 2, Ts1 may be greater than or equal to 40%, for example, 40% to 45%, and Ts2 may be greater than or equal to 40%, for example, 40% to 45%.

According to one or more embodiments, the polarizing plate may have a color difference change rate ΔEab of 7 or less, for example, 0 to 7, as calculated according to Equation 4. Within this range, the polarizing plate can have good color value durability.

$$Δ Eab = {[ {( Δ Ls )}^{2} + {( Δ as )}^{2} + {( Δ bs )}^{2} ]}^{1 / 2} , \qquad Equation 4$$

where ΔLs is L₂−L₁, Δas is (as)₂−(as)₁, and Δbs is (bs)₂−(bs)₁; L₁ is an initial L value of the polarizing plate, and L₂ is an L value of the polarizing plate after the polarizing plate is left at 105° C. for 1,500 hours; (as)₁ is an initial value as of the polarizing plate and (as)₂ is an as value of the polarizing plate after the polarizing plate is left at 105° C. for 1,500 hours; and (bs)₁ is an initial value bs of the polarizing plate, and (bs)₂ is a bs value of the polarizing plate after the polarizing plate is left at 105° C. for 1,500 hours.

According to one or more embodiments, the polarizing plate has a color value as of −1.9 to −2.4, for example, −2.1 to −2.2, and a color value bs of 9.7 to 10.2, for example, 9.7 to 10.0, after being left at 105° C. for 1,500 hours. These values may represent the absence of reddening and yellowing after the polarizing plate is left at 105° C. for 1,500 hours.

According to one or more embodiments, the polarizing plate includes a polarizer and a protective layer disposed on at least one surface of the polarizer, wherein the polarizer is formed of a polyvinyl alcohol based film containing a dichroic material and contains zinc cations and potassium cations, and wherein the polarizing plate has a value of 0.1 or less, as calculated by Equation 1:

$$Tc ( 400 nm ) / Tc ( 730 nm ) , \qquad Equation 1$$

where Tc (400 nm) is a cross transmittance of the polarizing plate at a wavelength of 400 nm (unit: %), and Tc (730 nm) is a cross transmittance of the polarizing plate at a wavelength of 730 nm (unit: %).

Equation 1 determines whether a polarizing plate formed of a polyvinyl alcohol based film containing a dichroic material has a significantly low change rate of light transmittance and is free from reddening and yellowing even after the polarizing plate is left at 105° C. for 1,500 hours or more. A polarizing plate having a value of 0.1 or less in Equation 1 can provide a significantly low change rate of light transmittance and can prevent or substantially prevent reddening or yellowing even after being left at 105° C. for 1,500 hours or more, when the polarizer is formed of a polyvinyl alcohol based film containing a dichroic material.

In an embodiment, the value of Equation 1 may be greater than 0 and less than or equal to 0.1, for example, greater than 0 and less than or equal to 0.08, for example 0.01, 0.02, 0.03, 0.04, 0.05, 0.06, 0.07, 0.08, 0.09, 0.1, 0.01 to 0.07, or 0.03 to 0.07. Within this range, the polarizing plate can secure the above effects and a thin polarizer can be easily manufactured.

In an embodiment, Tc (400 nm) of Equation 1 may be 0.01% or less, for example, 0.001, 0.002, 0.003, 0.004, 0.005, 0.006, 0.007, 0.008, 0.009, or 0.01%, and, in an embodiment, 0.001% to 0.008%, and, in an embodiment, 0.002% to 0.007%. In an embodiment, Tc (730 nm) of Equation 1 may be 0.05% to 0.20%, for example, 0.05, 0.06, 0.07, 0.08, 0.09, 0.10, 0.11, 0.12, 0.13, 0.14, 0.15, 0.16, 0.17, 0.18, 0.19, or 0.20%, and, in an embodiment, 0.06% to 0.19%, and, in an embodiment, 0.08% to 0.16%. Within these ranges, a value of 0.1 or less in Equation 1 can be easily achieved and the polarizer can be easily manufactured.

The polarizer contains zinc cations and potassium cations. The zinc cations and the potassium cations in the polarizer can facilitate prevention of the polarizing plate from reddening and yellowing after being left at 105° C. for 1,500 hours or more. A polarizing plate including a polarizer containing only potassium cations without zinc cations can experience reddening and/or yellowing after being left at 105° C. for 1,500 hours or more, and cannot satisfy high temperature reliability. The zinc cations can be advantageous for reducing the change rate of light transmittance of the polarizing plate without causing reddening and/or yellowing after being left at 105° C. for 1,500 hours or more, even when the content of potassium cations in the polarizer is increased. A polarizing plate including a polarizer containing only the zinc cations without the potassium cations can experience reddening and/or yellowing after being left at 105° C. for 1,500 hours or more and cannot satisfy high temperature reliability.

According to an embodiment, the polarizer may contain 0.15 wt % or more of the zinc cations, for example, 0.15, 0.16, 0.17, 0.18, 0.19, 0.20, 0.21, 0.22, 0.23, 0.24, or 0.25 wt %, and, in an embodiment, 0.18 wt % or more, and, in an embodiment, 0.18 wt % to 0.25 wt %. Within this range, the polarizing plate can prevent or substantially prevent reddening and yellowing while reducing the change rate of light transmittance even upon increase in the content of potassium cations in the polarizer.

According to an embodiment, the polarizer may contain 0.55 wt % or more of the potassium cations, for example, 0.55, 0.56, 0.57, 0.58, 0.59, 0.60, 0.61, 0.62, 0.63, 0.64, 0.65, 0.66, 0.67, 0.68, 0.69, or 0.70 wt %, and, in an embodiment, 0.59 wt % or more, and, in an embodiment, 0.59 wt % to 0.70 wt %. Within this range, the polarizing plate can easily prevent or substantially prevent reddening and yellowing even after being left at high temperature for a long period of time.

According to an embodiment, the polarizer may contain the potassium cations and the zinc cations in a weight ratio (zinc cations:potassium cations) of 1:2.5 or more, for example, 1:2.5, 2.6, 2.7, 2.8, 2.9, 3.0, 3.1, 3.2, 3.3, 3.4, 3.5, 3.6, 3.7, 3.8, 3.9, or 4.0, and, in an embodiment, 1:2.5 to 4.0, and, in an embodiment, 1:2.5 to 3.5. Within this range, the polarizing plate can easily provide the aforementioned effects.

According to an embodiment, the total content of the zinc cations and the potassium cations in the polarizer may be 0.60 wt % or more, for example, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, or 0.9 wt %, and, in an embodiment, 0.60 wt % to 0.9 wt %. Within this range, the polarizing plate can easily provide the above effects.

The content of the potassium cations and the content of the zinc cations in the polarizer may be controlled by adjusting the content of each of a potassium cation source and a zinc cation source used in a process of manufacturing the polarizer.

For the polarizing plate, a value of 0.1 or less of Equation 1 may be realized through a color correction process and a drying process during the process of manufacturing the polarizer. In an embodiment, the concentration of the potassium cation source in a color correction solution in a color correction bath for the color correction process and the temperature of the color correction solution may be adjusted. In an embodiment, the drying temperature may be adjusted in a drying zone where the drying process is performed.

FIG. 3 is a graph depicting a relationship between cross transmittance and wavelength for polarizers prepared by a polarizer manufacturing process described below while changing the content of potassium iodide in the color correction solution, with the content of zinc sulfate as a zinc cation source in the color correction solution maintained at 4 wt %.

Referring to FIG. 3, it can be seen that, when the content of potassium iodide in the color correction solution reaches 5.9 wt % or more, the cross transmittance at wavelength 730 nm is significantly increased and a value of 0.1 or less in Equation 1 can be easily achieved.

In FIG. 3, a solid line indicates a case in which the concentration of potassium iodide in the color correction solution is 5.9 wt %, ● indicates a case in which the drying temperature of the polarizer is 60° C./70° C./80° C., ▪ indicates a case in which the drying temperature of the polarizer is 70° C./80° C./90° C., in the dotted line, ∘ indicates a case in which the concentration of potassium iodide in the color correction solution is 4.5 wt %, □ indicates a case in which the concentration of potassium iodide in the color correction solution is 4.0 wt %, Δ indicates a case in which the concentration of potassium iodide in the color correction solution is 3.0 wt %, and ● indicates a case in which the concentration of potassium iodide in the color correction solution is 1.5 wt %.

These cases will be described in further detail in the polarizer manufacturing process described below.

The polarizer is a linear light absorption polarizer that can provide a polarization function by transmitting only a fraction of incident light in one direction while absorbing a fraction of incident light perpendicular to the one direction.

The polarizer is formed of a polyvinyl alcohol based film containing a dichroic material. Here, the polyvinyl alcohol based film may include not only a polyvinyl alcohol resin, but also a derivative resin thereof. For example, the polarizer may be a polarizer including a polyvinyl alcohol based film including a polyvinyl alcohol derivative resin or composed only of a polyvinyl alcohol derivative resin.

In an embodiment, the polyvinyl alcohol derivative may contain a hydrophilic functional group and a hydrophobic functional group. The hydrophobic functional group may be present together with the hydrophilic functional groups in the polyvinyl alcohol, which are hydroxyl groups (OH groups). The hydrophobic functional groups may be present in at least one of a main chain or a side chain of the polyvinyl alcohol derivative. Here, the main chain means a part constituting a main backbone of the polyvinyl alcohol derivative and the side chain means a backbone connected to the main chain. In an embodiment, the hydrophobic functional groups are present in the main chain of the polyvinyl alcohol derivative.

The polyvinyl alcohol derivative with the hydrophilic and hydrophobic functional groups may be prepared by polymerizing one or more vinyl ester monomers, such as vinyl acetate, vinyl formate, vinyl propionate, vinyl butyrate, vinyl pivalate, vinyl isopropenyl acetate, and the like, with a monomer providing a hydrophobic functional group. In an embodiment, the vinyl ester monomer includes vinyl acetate. The monomer providing the hydrophobic functional group may include a monomer providing hydrocarbon repeat units including ethylene, propylene, and the like.

In an embodiment, the polyvinyl alcohol based film may have a softening point of 66° C. to 70° C., for example, 67° C. to 69° C. Within this range, the polyvinyl alcohol based film does not suffer from melting and fracture in a stretching process and can easily form the polarizer according to the present invention.

In an embodiment, the polyvinyl alcohol based film may have a tensile strength of 95 MPa to 105 MPa, and, in an embodiment, 97 MPa to 99 MPa, as measured in the machine direction thereof. Within this range, the polyvinyl alcohol based film does not suffer from melting and fracture in the stretching process, can allow polyvinyl alcohol molecular chains to effectively oriented to provide a high degree of polarization, and can easily form the polarizer. The tensile strength of the polyvinyl alcohol based film can be measured at 25° C. in accordance with ASTM D882 using a Universal Testing Machine (UTM).

The polyvinyl alcohol based film may have a thickness of 50 μm or less, for example, 10 μm to 50 μm. Within this range, the polyvinyl alcohol based film does not suffer from melting and fracture in the stretching process.

The polyvinyl alcohol based film may include a TS-#4500 (or higher, Kuraray Co., Ltd., Japan) PVA film, without being limited thereto.

The polyvinyl alcohol based film may be dyed with a dichroic material. The dichroic material may include an iodine based material or dichroic dyes, such as azo dyes, as a non-iodine material. The iodine based material may be iodine and may include at least one selected from among potassium iodide, hydrogen iodide, lithium iodide, sodium iodide, zinc iodide, aluminum iodide, lead iodide, and copper iodide.

At least one type of the potassium cations or the zinc cations may be present in at least a region on a surface of the polarizer or may be present within the polarizer. In an embodiment, at least one type of the potassium cations or the zinc cations is present within the polarizer to facilitate extension of a reliability providing period.

The potassium cations may be derived from a potassium cation source added during the polarizer manufacturing process. For example, the potassium cations may be derived from potassium iodide (KI).

The zinc cations may be derived from a zinc cation source added during the polarizer manufacturing process. For example, the zinc cations may be derived from at least one of zinc sulfate (ZnSO₄), zinc chloride (ZnCl₂), zinc iodide (ZnI₂), zinc nitrate (Zn(NO₃)₂), or zinc acetate (Zn(CH₃CO₂)₂). In an embodiment, the zinc cations are derived from zinc sulfate, whereby the ratio of Equation 1 can be easily achieved.

In an embodiment, the polarizer may have a thickness of 20 μm or less, for example, greater than 0 μm and less than or equal to 20 μm, for example, 10 μm to 20 μm, or 17 μm to 19 μm. Within this range, the polarizer can be used in the polarizing plate.

Next, the polarizer manufacturing method will be described in further detail.

The polarizer may be manufactured by a method including a dyeing process, a stretching process, a color correction process, and a drying process.

In an embodiment, the polarizer may be manufactured by sequentially performing the dyeing process, the stretching process, the color correction process, and the drying process.

According to an embodiment, the method may further include a cross-linking process. According to an embodiment, the method may further include a washing process and a swelling process of the polyvinyl alcohol film prior to the dyeing process.

### Dyeing Process

The dyeing process includes treatment of a polyvinyl alcohol based film in a dyeing bath containing a dichroic material. In the dyeing process, the polyvinyl alcohol based film is dipped in the dyeing bath containing the dichroic material. The dyeing bath containing the dichroic material includes a dyeing solution (aqueous solution) containing the dichroic material and boric acid. As the dyeing bath includes both the dichroic material and a boron compound, the dyed polyvinyl alcohol film can be prevented or substantially prevented from fracture when stretched under stretching conditions described below.

The dichroic material is iodine and may include at least one selected from among potassium iodide, hydrogen iodide, lithium iodide, sodium iodide, zinc iodide, aluminum iodide, lead iodide, and copper iodide. In an embodiment, the dichroic material may be present in an amount of 0.1 wt % to 10 wt %, for example 0.1 wt % to 2 wt %, in the dyeing bath, and, in an embodiment, in the dyeing solution. Within this range, uniform dyeing can be achieved.

The boron compound can assist in prevention of melting and fracture of the polyvinyl alcohol based film upon stretching of the polyvinyl alcohol based film. The boron compound can assist in prevention of melting and fracture of the polyvinyl alcohol based film in the subsequent stretching process even when the polyvinyl alcohol based film is stretched at high temperature and high stretching ratio.

The boron compound may include at least one of boric acid or borax. In an embodiment, the boron compound may be present in an amount of 0.1 wt % to 5 wt %, and, in an embodiment, 0.3 wt % to 3 wt %, in the dyeing bath, and, in an embodiment, in the dyeing solution. Within this range, the polyvinyl alcohol film does not suffer from melting and fracture in the stretching process and can achieve high reliability

In an embodiment, the dyeing solution may have a temperature of 20° C. to 50° C., and, in an embodiment, 25° C. to 40° C. In an embodiment, the dyeing process may be performed by dipping the polyvinyl alcohol film in the dyeing bath for 30 seconds to 120 seconds, and, in an embodiment, 40 seconds to 80 seconds.

### Stretching Process

The stretching process includes uniaxially stretching the dyed polyvinyl alcohol based film at a stretching ratio of 5 times or more, for example, 5 times to 7 times, at 55° C. or more, for example, at 55° C. to 65° C., in the machine direction of the polyvinyl alcohol based film. A typical polyvinyl alcohol based film cannot be formed into a polarizer due to melting and/or fracture upon stretching at the stretching ratio and the temperature within the above ranges.

The stretching process is performed by either wet stretching or dry stretching. In an embodiment, the stretching process includes wet stretching in order to apply the boron compound in the stretching process. Wet stretching includes uniaxial stretching of the polyvinyl alcohol based film in an aqueous solution containing a boron compound in the machine direction.

The boron compound may include at least one of boric acid or borax. In an embodiment, the boron compound may be present in an amount of 0.5 wt % to 10 wt %, and, in an embodiment, 1 wt % to 5 wt %, in a stretching bath, and, in an embodiment, in a stretching solution. Within this range, the polyvinyl alcohol based film does not suffer from melting and fracture in the stretching process and can achieve high reliability.

### Color Correction Process

The color correction process improves durability of the polyvinyl alcohol based film and makes it easy to achieve the ratio in Equation 1.

The color correction process may be performed by dipping and leaving the polyvinyl alcohol based film in a color correction bath. The color correction bath may contain a color correction solution (aqueous solution) containing a potassium cation source and a zinc cation source. As a result, the potassium cations and the zinc cations can be introduced into the polarizer by the same process in manufacture of the polarizer.

The zinc cation source may include at least one selected from among zinc sulfate, zinc chloride, zinc iodide, zinc nitrate, and zinc acetate. In an embodiment, the zinc cation may be derived from zinc sulfate, which makes it easy to achieve the effects of the present invention described above.

In an embodiment, the zinc cation source may be present in an amount of 0.01 wt % to 5 wt %, for example, 2 wt % to 5 wt %, or 3 wt % to 5 wt %, in the color correction bath. Within this range, the polyvinyl alcohol film can easily form the polarizer according to the present invention.

The potassium cation source may include potassium iodide.

In an embodiment, the potassium cation source may be present in an amount of 4.5 wt % to 15 wt %, for example, 5.5 wt % to 10 wt %, in the color correction solution. Within this range, the polyvinyl alcohol based film can easily form the polarizer according to the present invention. In an embodiment, the potassium cation source is present in an amount of 5.5 wt % to 10 wt % in the color correction solution. Within this range, the polyvinyl alcohol based film can easily form the polarizer satisfying Equation 1.

In an embodiment, in the color correction process, the color correction solution may have a temperature of 20° C. to 50° C., and, in an embodiment, 25° C. to 40° C. In an embodiment, the color correction process may be performed by dipping the polyvinyl alcohol based film in the color correction bath for 5 seconds to 30 seconds, and, in an embodiment, for 5 seconds to 20 seconds.

### Drying Process

The drying process improves durability of the polarizer and makes it easy to achieve the ratio in Equation 1.

The drying process may be performed by hot air drying, without being limited thereto. Since hot air drying utilizes heated air or gas as a drying medium, which does not require direct heating of the polyvinyl alcohol based film, the polyvinyl alcohol based film does not suffer from local overheating. In addition, since hot air drying is performed through introduction of freshly heated drying air to establish new gas phase equilibrium rather than static equilibrium, hot air drying can result in uniform drying of the polyvinyl alcohol based film.

In an embodiment, the drying process may be performed in a single step or may be performed in multiple steps to ensure that the polyvinyl alcohol based film does not suffer from damage due to local heating.

In an embodiment, the drying process may be performed in three steps. Here, the three steps include a first step (drying temperature T1), a second step (drying temperature T2), and a third step (drying temperature T3) performed successively (T1<T2<T3). For example, the drying temperature T1 may be in a range from 60° C. to 70° C., the drying temperature T2 may be in a range from 70° C. to 80° C., and the drying temperature T3 may be in a range from 80° C. to 90° C. Within these ranges, the polyvinyl alcohol based film can easily form the polarizer of the present invention.

The polyvinyl alcohol based film may be subjected to the washing process and/or the swelling process before the dyeing process.

In the washing process, the polyvinyl alcohol based film is washed with water to remove foreign matter from the polyvinyl alcohol based film.

In the swelling process, the polyvinyl alcohol based film is dipped in a swelling bath in a temperature range (e.g., a predetermined temperature range) to facilitate dyeing with the dichroic material and stretching. In an embodiment, the swelling process may be performed in an aqueous solution at 15° C. to 35° C., and, in an embodiment, at 20° C. to 30° C., for 30 seconds to 50 seconds.

The crosslinking process may be performed to enhance adsorption of the dichroic material to the polyvinyl alcohol based film. A crosslinking solution used in the crosslinking process may include a boron compound. The boron compound can assist in enhanced adsorption of the dichroic material described above while improving reliability of the polarizer even when the polarizer is left under a thermal shock condition.

The boron compound may include at least one of boric acid or borax. In an embodiment, the boron compound may be present in an amount of 0.5 wt % to 10 wt %, and, in an embodiment, 1 wt % to 5 wt %, in a crosslinking bath, and, in an embodiment, in the crosslinking aqueous solution. Within this range, the polyvinyl alcohol based film does not suffer from melting and fracture in the stretching process and can achieve high reliability. In an embodiment, the crosslinking bath may have a temperature of 20° C. to 50° C., and, in an embodiment, 25° C. to 40° C. In an embodiment, the crosslinking process may be performed by dipping the polyvinyl alcohol based film in the crosslinking bath for 30 seconds to 120 seconds, and, in an embodiment, for 40 seconds to 80 seconds.

The manufacturing method may further include a cleaning process between the processes. The cleaning process may include washing the polyvinyl alcohol film with water, or may include washing the polyvinyl alcohol film with an aqueous solution containing boric acid and/or potassium iodide.

The protective layer may be formed on a surface of the polarizer to protect the polarizer. In an embodiment, the protective layer may have a range (e.g., a predetermined range) of phase retardation to provide an additional function to the polarizing plate, for example, an optical compensation function and the like.

The protective layer may include an optically clear protective film or protective coating layer.

The protective film may be formed by melting and extrusion of a composition for the protective film including at least one organic component selected from among optically transparent resins, oligomers, and monomers. The protective film may be subjected to a stretching process, as needed. The organic component may include at least one selected from among cellulose ester resins including triacetylcellulose and the like, cyclic polyolefin resins including an amorphous cyclic olefin polymer (COP) and the like, polycarbonate resins, polyester resins including polyethylene terephthalate (PET) and the like, polyethersulfone resins, polysulfone resins, polyamide resins, polyimide resins, non-cyclic polyolefin resins, polyacrylate resins including polymethyl methacrylate and the like, polyvinyl alcohol resins, polyvinyl chloride resins, and polyvinylidene chloride resins.

In an embodiment, the protective layer may be a monolayer film or a multilayer film stack.

In an embodiment, the protective layer may have a thickness of 5 μm to 200 μm, and, in an embodiment, 10 μm to 100 μm, and, in an embodiment, 60 μm to 100 μm. Within this range, the protective layer can be used in the polarizing plate.

A functional coating layer, for example, any of a hard coating layer, an anti-fingerprint layer, an antireflection layer, and a primer layer, may be further formed on at least one surface of the protective layer.

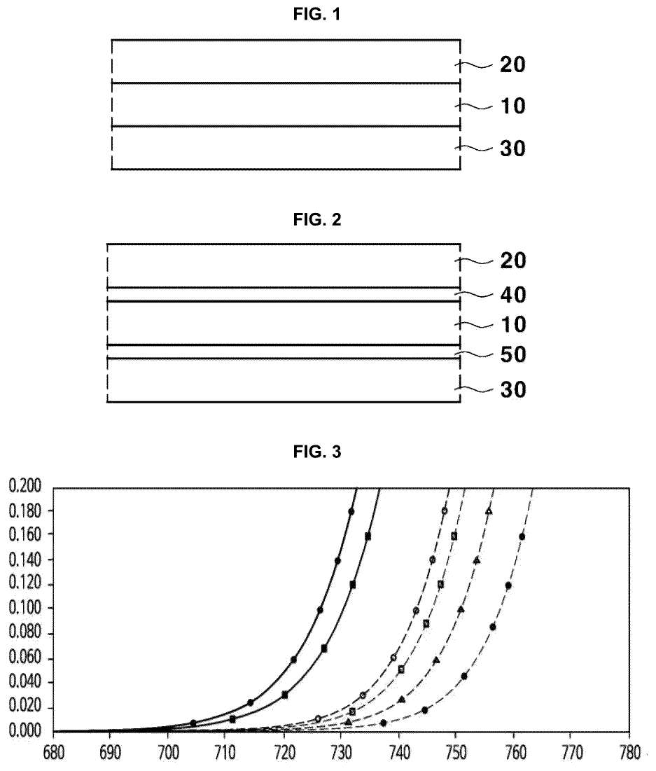

Referring to FIG. 1, a polarizing plate may include a polarizer 10, a first protective layer 20 formed on a surface of the polarizer 10, and a second protective layer 30 formed on another surface of the polarizer 10.

Referring to FIG. 2, a polarizing plate may include a polarizer 10, a first protective layer 20 formed on a surface of the polarizer 10 via a first bonding layer 40, and a second protective layer 30 on another surface of the polarizer 10 via a second bonding layer 50.

The polarizer 10 may be substantially the same as the polarizer described above.

The first protective layer 20 and the second protective layer 30 may be substantially the same as the protective layer described above.

In an embodiment, as shown in FIG. 1, the first protective layer 20 and the second protective layer 30 may be directly formed on the polarizer 10 by coating, deposition, curing, or the like. However, as shown in FIG. 2, in an embodiment, the first protective layer 20 and the second protective layer 30 may be stacked on the polarizer 10 by the first bonding layer 40 and the second bonding layer 50, respectively.

Each of the first bonding layer 40 and the second bonding layer 50 may be formed by a typical bonding agent for polarizing plates known to those skilled in the art. For example, the bonding layers may be formed by a water-based bonding agent or a photo-curable bonding agent.

The water-based bonding agent may include any of a polyvinyl alcohol-based bonding resin, a crosslinking agent, and the like.

The photo-curable bonding agent may include at least one of an epoxy compound or a (meth)acrylic compound, and an initiator. The initiator may include at least one of a photo-radical initiator or a photo-cationic initiator, and, in an embodiment, a mixture of a photo-radical initiator and a photo-cationic initiator. The photo-curable bonding agent may further include typical additives, such as antioxidants, pigments, and the like.

In an embodiment, each of the first bonding layer 40 and the second bonding layer 50 may have a thickness of 0.05 μm to 10 μm. Within this range, the bonding layers can be used in an optical display apparatus.

In an embodiment, the polarizing plate may have a degree of polarization (PE) of 99% or more, for example, 99.99% or more. Within this range, the polarizing plate with a high degree of polarization can be used in optical indicators.

According to an embodiment, an optical display apparatus includes the polarizing plate according to an embodiment of the present invention.

The optical display apparatus may include at least one of a liquid crystal display or a light emitting display.

In an embodiment, the light emitting display includes an organic light emitting device or an organic-inorganic light emitting device as a light emitting device. Here, the light emitting device may refer to a light emitting diode (LED), an organic light emitting diode (OLED), a quantum dot light emitting diode (QLED), or a device including a light emitting material, such as phosphors and the like. The light emitting display may include the light emitting device and a polarizing plate disposed on a light exit surface of the light emitting device, wherein the polarizing plate may include the polarizing plate according to an embodiment of the present invention.

The liquid crystal display includes a backlight unit, a liquid crystal panel, a light source-side polarizing plate disposed between the backlight unit and a surface of the liquid crystal panel, and a viewer-side polarizing plate disposed on another surface of the liquid crystal panel, in which at least one of the light source-side polarizing plate or the viewer-side polarizing plate may include the polarizing plate according to an embodiment of the present invention.

Next, the present invention will be described in further detail with reference to some examples. However, these examples are provided for illustration and are not to be construed in any way as limiting the present invention.

### Example 1

### (1) Manufacture of Polarizer

A polyvinyl alcohol based film (TS-#4500, containing a hydrophobic functional group in a main chain, thickness: 45 μm, Kuraray Co., Ltd., Japan) washed with water being 25° C. was subjected to swelling treatment with water being 30° C. in a swelling bath.

After swelling treatment, the film was dipped in a dyeing bath, which was filled with an aqueous solution containing 0.6 wt % of potassium iodide (KI) and 1 wt % of boric acid and being 30° C. for 65 seconds. After dyeing treatment, the film was uniaxially stretched to 6 times an initial length thereof in the machine direction (MD) in a wet stretching bath filled with an aqueous solution containing 3.0 wt % of boric acid and being 60° C.

The film was dipped in a color correction bath containing an aqueous color correction solution containing 4 wt % of zinc sulfate (ZnSO₄) and 6 wt % potassium iodide and being 25° C. for 10 seconds, followed by washing. The washed film was dried with hot air in a hot air dryer in the order of temperature T1 (60° C.)/temperature T2 (70° C.)/temperature T3 (80° C.), thereby preparing a polarizer (thickness: 17 μm).

### (2) Manufacture of Polarizing Plate

A water-based bonding agent (containing a polyvinyl alcohol-based bonding resin) was applied to both surfaces of the prepared polarizer, followed by attaching a triacetylcellulose (TAC) film (thickness: 45 μm, CHP2SD) formed with a hard coating layer and a zero triacetylcellulose film (thickness: 20 μm, KC2CT1W) to upper and lower surfaces of the polarizer, respectively, thereby preparing a polarizing plate.

### Example 2

A polarizing plate was prepared in the same manner as in Example 1 except for the temperatures T1/T2/T3 during hot air drying, as listed in Table 1.

### Comparative Examples 1 to 6

Polarizing plates were prepared in the same manner as in Example 1 except that the concentrations of zinc sulfate and potassium iodide in the color correction solution, the temperature of the color correction solution, and the temperatures T1/T2/T3 during hot air drying were changed as listed in Table 1.

Each of the polarizing plates of the Examples and Comparative Examples was evaluated as to the properties shown in Table 1. Results are shown in Table 2.

(1) Concentrations of K⁺ and Zn²⁺ in polarizer (unit: wt %): Concentrations of K⁺ and Zn²⁺ in each of the polarizers prepared in the Examples and Comparative Examples were measured by the ICP-OES method using a 5100 series (Agilent).

(2) Cross transmittance of polarizing plate (Tc, unit: %): The polarizing plate was cut to a size of 3 cm×3 cm (machine direction (MD)×transverse direction (TD) of the polarizer) and was attached to a glass plate using an acrylic adhesive (SDI Ltd.) to prepare a specimen. Cross transmittance of the prepared specimen was measured using a V-7100 (Jasco Corp.).

(3) Single transmittance change rate of polarizing plate (unit: %): The polarizing plate was cut to a size of 3 cm×3 cm (MD×TD of the polarizer) and was attached to a glass plate using an acrylic adhesive (SDI Ltd.) to prepare a specimen. An initial single transmittance (Ts1) of the prepared specimen was measured using a V-7100 (Jasco Corp.). Then, the specimen was left in a chamber at 105° C. for 1,500 hours, followed by measurement of single transmittance (Ts2) of the polarizing plate by the same method as above. A single transmittance change rate of the polarizing plate was calculated according to Equation 2 with Ts1 and Ts2.

(4) Reddening and yellowing: The polarizing plate was cut to a size of 3 cm×3 cm (MD×TD of the polarizer) and then left in a chamber at 105° C. for 1,500 hours. Reddening and yellowing of the polarizing plate were visually evaluated based on an initial state of the polarizing plate. No reddening and yellowing was evaluated as X, much reddening and yellowing was evaluated as ∘, and too much reddening and yellowing was evaluated as ⊚.

(5) Single transmittance change rate of polarizing plate (unit: %): The polarizing plate was cut to a size of 3 cm×3 cm (MD×TD of the polarizer) and was attached to a glass plate using an acrylic adhesive (SDI Ltd.) to prepare a specimen. An initial single transmittance (Ts1) of the prepared specimen was measured using a V-7100 (Jasco Corp.). Then, the specimen was left in a chamber at 100° C. for 24 hours, followed by measurement of single transmittance (Ts3) of the polarizing plate by the same method as above. A single transmittance change rate of the polarizing plate was calculated according to Equation 3 with Ts1 and Ts3.

$$Single transmittance change rate = [ \vert Ts 3 - Ts 1 \vert / Ts 1 ] \times 100 , \qquad Equation 3$$

where Ts1 is an initial single transmittance of the polarizing plate (unit: %), and Ts3 is a single transmittance of the polarizing plate after the polarizing plate is left at 100° C. for 24 hours (unit: %).

(6) ΔEab; Each of the polarizing plates of the Examples and Comparative Examples was cut to a size of 6 cm×6 cm (MD×TD of the polarizer) and was attached to a glass plate using an acrylic adhesive (SDI Ltd.), followed by covering the polarizing plate with an adhesive and a glass plate to prepare a specimen. Luminance and color values of the specimen were measured using a colorimeter (CM-3700A, Konica Minolta) before and after the specimen was left at 105° C. for 1,500 hours. ΔEab was calculated according to Equation 4.

TABLE 1

| | Color correction bath | | | |
|---|---|---|---|---|
| | | | Temperature | Drying temperature |
| | ZnSO₄ | KI | (° C.) | (° C.) |
| Example 1 | 4 | 6 | 25 | 60/70/80 |
| Example 2 | 4 | 6 | 25 | 70/80/90 |
| Comparative | 2 | 4.5 | 25 | 60/70/80 |
| Example 1 | | | | |
| Comparative | 4 | 1.5 | 25 | 60/70/80 |
| Example 2 | | | | |
| Comparative | 4 | 3 | 25 | 60/70/80 |
| Example 3 | | | | |
| Comparative | 4 | 4.5 | 35 | 60/70/80 |
| Example 4 | | | | |
| Comparative | 4 | 4.5 | 25 | 60/70/80 |
| Example 5 | | | | |
| Comparative | 4 | 4.5 | 25 | 80/90/100 |
| Example 6 | | | | |

TABLE 2

| | | | Initial Tc | | | Ts (105° C.) | | | | | | |
|---|---|---|---|---|---|---|---|---|---|---|---|---|
| | Polarizer | | 400 | 730 | | 0 hr | 1,500 hr | | | | | |
| | K | Zn | nm | nm | Eq. 1 | Ts | Ts | Eq. 2 | Reddening | Yellowing | Eq. 3 | ΔEab |
| Example 1 | 0.61 | 0.19 | 0.0064 | 0.0944 | 0.07 | 42.14 | 41.05 | 2.6% | X | X | 1.5% | 6.7 |
| Example 2 | 0.61 | 0.19 | 0.0043 | 0.1482 | 0.03 | 42.15 | 41.06 | 2.6% | X | X | 1.3% | 6.4 |
| Comparative | 0.72 | 0.15 | 0.0053 | 0.0310 | 0.17 | 42.04 | 37.13 | 11.7% | ◯ | ◯ | 1.6% | 12.6 |
| Example 1 | | | | | | | | | | | | |
| Comparative | 0.29 | 0.11 | 0.0232 | 0.0029 | 7.93 | 41.76 | 7.62 | 81.8% | ◯ | ⊚ | 0.5% | 47.5 |
| Example 2 | | | | | | | | | | | | |
| Comparative | 0.41 | 0.16 | 0.0078 | 0.0064 | 1.21 | 41.81 | 13.75 | 67.1% | ◯ | ⊚ | 0.9% | 38.5 |
| Example 3 | | | | | | | | | | | | |
| Comparative | 0.52 | 0.30 | 0.0079 | 0.0253 | 0.31 | 41.96 | 39.22 | 6.5% | ◯ | ◯ | 1.1% | 9.2 |
| Example 4 | | | | | | | | | | | | |
| Comparative | 0.49 | 0.22 | 0.0057 | 0.0198 | 0.29 | 41.80 | 35.62 | 14.8% | ◯ | ◯ | 1.3% | 15.3 |
| Example 5 | | | | | | | | | | | | |
| Comparative | 0.49 | 0.22 | 0.0056 | 0.0443 | 0.13 | 42.04 | 37.54 | 10.7% | ◯ | ◯ | 0.9% | 12.0 |
| Example 6 | | | | | | | | | | | | |

*ln Equation 1, the drying temperatures are listed in the order of T1/T2/T3.
*Glass plates and acrylic adhesives do not affect measurements of cross transmittance and single transmittance of the polarizing plate.

As can be seen from Table 1, the polarizing plates according to the present invention exhibited a significantly low light transmittance change rate even after being left at 105° C. for 1,500 hours or more, and suffered no reddening and yellowing even after being left at 105° C. for 1,500 hours or more.

Conversely, the polarizing plates of the Comparative Examples failed to obtain the advantageous effects of the present invention.

While some example embodiments have been described herein, it is to be understood that various modifications, changes, alterations, and equivalent embodiments can be made by those skilled in the art without departing from the spirit and scope of the present invention.

What is claimed is:

1. A polarizing plate comprising a polarizer and a protective layer on at least one surface of the polarizer,
wherein the polarizer comprises a polyvinyl alcohol based film containing a dichroic material and contains zinc cations and potassium cations, and
wherein the polarizing plate has a value of 0.1 or less, as calculated according to the following Equation 1:
$$Tc ( 400 nm ) / Tc ( 730 nm ) ,$$
where Tc (400 nm) is a cross transmittance of the polarizing plate at a wavelength of 400 nm (unit: %), and Tc (730 nm) is a cross transmittance of the polarizing plate at a wavelength of 730 nm (unit: %).

2. The polarizing plate as claimed in claim 1, wherein Tc (400 nm) is 0.010% or less and Tc (730 nm) is from 0.05% to 0.20%.

3. An optical display apparatus comprising the polarizing plate as claimed in claim 2.

4. The polarizing plate as claimed in claim 1, wherein the zinc cations are present in an amount of 0.15 wt % or more, and the potassium cations are present in an amount of 0.55 wt % in the polarizer.

5. An optical display apparatus comprising the polarizing plate as claimed in claim 4.

6. The polarizing plate as claimed in claim 1, wherein the polarizer contains the zinc cations and the potassium cations in a total amount of 0.60 wt % or more.

7. An optical display apparatus comprising the polarizing plate as claimed in claim 6.

8. The polarizing plate as claimed in claim 1, wherein the polarizer contains the zinc cations and the potassium cations in a weight ratio (zinc cations:potassium cations) of 1:2.5 or more.

9. An optical display apparatus comprising the polarizing plate as claimed in claim 8.

10. The polarizing plate as claimed in claim 1, wherein the polyvinyl alcohol based film comprises a derivative of polyvinyl alcohol containing a hydrophilic functional group and a hydrophobic functional group.

11. An optical display apparatus comprising the polarizing plate as claimed in claim 10.

12. The polarizing plate as claimed in claim 1, wherein the polarizing plate has a single transmittance change rate of 3% or less, as calculated according to the following Equation 2:
$$s ingle transmittance change rate = [ \vert Ts 2 - Ts 1 \vert / Ts 1 ] \times 100 ,$$
where Ts1 is an initial single transmittance of the polarizing plate (unit: %), and Ts2 is a single transmittance of the polarizing plate after the polarizing plate is left at 105° C. for 1,500 hours (unit: %).

13. An optical display apparatus comprising the polarizing plate as claimed in claim 12.

14. An optical display apparatus comprising the polarizing plate as claimed in claim 1.
